(19) United States
(12) Patent Application Publication
(10) Pub. No.: US 2022/0358182 A1
(43) Pub. Date: Nov. 10, 2022

(54) SCALABLE ERROR MITIGATION

(71) Applicant: International Business Machines Corporation, Armonk, NY (US)

(72) Inventors: Paul Nation, Yorktown Heights, NY (US); Hwajung Kang, Yorktown Heights, NY (US); Jay Michael Gambetta, Yorktown Heights, NY (US)

(21) Appl. No.: 17/314,339

(22) Filed: May 7, 2021

(51) Int. Cl. G06F 17/16; G06N 10/00

(52) U.S. Cl. CPC G06F 17/16; G06N 10/00

(57) ABSTRACT

Systems, computer-implemented methods and/or computer program products are provided for facilitating error mitigation for classical data output from a classical system and/or for qubit data output from a quantum system. A system can comprise a memory that stores computer executable components and a processor that executes the computer executable components stored in the memory. The computer executable components can comprise a computation component that performs error mitigation employing less than a full set of assignment matrix elements. In one or more embodiments, the error mitigation can be performed without constructing an assignment matrix. Additionally and/or alternatively, the computer executable components can comprise a computation component that performs error mitigation employing an iterative solver using the less than a full set of assignment matrix elements as the initial input set for the iterative solver.

### BACKGROUND

One or more embodiments described herein relate generally to error mitigation, and more specifically, to error mitigation employing a truncated matrix A to realize a faster and/or more efficient error-mitigated result.

Quantum computing generally involves the use of quantum-mechanical phenomena to perform computing and information processing functions. Quantum computing can employ quantum physics to encode and process information rather than binary digital techniques based on transistors. That is, while classical computers can operate on bit values that are either 0 or 1, a quantum computing device can employ quantum bits (also referred to as qubits) that can operate according to the laws of quantum physics and can exhibit phenomena such as superposition and/or entanglement.

The superposition principle of quantum physics can allow a qubit to be in a state that partially represents both a value of “1” and a value of “0” at the same time. The entanglement principle of quantum physics can allow qubits to be correlated. For instance, a state of a first qubit can depend on a state of a second qubit. As such, a quantum circuit can employ qubits to encode and process information in a manner that can be significantly different from binary digital techniques based on transistors. Indeed, quantum computing has the potential to solve problems that, due to computational complexity, cannot be solved or can only be solved slowly on a classical computer.

Quantum computing can utilize specialized controls, such as quantum circuits, to operate on qubits. Quantum circuits are transformations that can perform operations on qubits. Quantum circuits, for instance as part of a quantum program, can be implemented as one or more quantum gates, such as a sequence of quantum gates. The quantum gates can be implemented as one or more physical operations on a set of qubits, such as implementing a sequence of pulses. A pulse is a time-dependent tone (e.g., wave or waveform) that can be applied to a qubit to change a state of the qubit.

Quantum programming can involve the process of assembling sequences of instructions, which can be called quantum programs, that can be capable of running on a quantum computer. Each quantum program can be associated with a collection of quantum circuits. When a quantum program is executed, a result can be produced by the quantum computer. The performance of a quantum computer can depend in part not just on the fidelity of unitary gates of the quantum circuit, but also on the fidelity of a quantum readout of the result.

In quantum computers, there can be an undesirable amount of error in the quantum readout, such as of one or more qubits operated on in a quantum program. That is, operations on qubits generally can introduce some error, such as some level of decoherence and/or some level of quantum noise. Quantum noise can refer to noise attributable to the discrete and/or probabilistic natures of quantum interactions. The undesirable amount of error in the quantum readout can include one or more gate errors and/or readout measurement errors, among others. Readout measurement error can be attributable to imperfect qubit measurements, such as due to noise. One or more embodiments described herein can address one or more such concerns.

### SUMMARY

The following presents a summary to provide a basic understanding of one or more embodiments described herein. This summary is not intended to identify key or critical elements, or to delineate any scope of the particular embodiments and/or any scope of the claims. The sole purpose of the summary is to present concepts in a simplified form as a prelude to the more detailed description that is presented later. In one or more embodiments described herein, devices, systems, computer-implemented methods, apparatuses and/or computer program products are described that can facilitate performing error mitigation, such as on a classical or hybrid classical/quantum system.

According to an embodiment, a system can comprise a memory that stores computer executable components and a processor that executes the computer executable components stored in the memory. The computer executable components can comprise a computation component that performs error mitigation employing less than a full set of assignment matrix (A-matrix) elements.

According to another embodiment, a computer-implemented method can comprise performing, by a system operatively coupled to a processor, error mitigation employing less than a full set of assignment matrix (A-matrix) elements.

According to still another embodiment, a computer program product for facilitating error mitigation can comprise a computer readable storage medium having program instructions embodied therewith. The program instructions can be executable by a processor to perform, by the processor, error mitigation employing less than a full set of assignment matrix (A-matrix) elements.

An advantage of such system, computer program product and/or method can be a scalable and/or matrix-free approach to error mitigation that can account for increased bitstring quantity. Relative to a quantum system, such scalable and/or matrix-free approach to error mitigation can account for increased qubit count above that which is feasible using current error mitigation approaches and/or techniques. Furthermore, even relative to lower bitstring quantities and/or lower qubit count, for which current error mitigation approaches can be able to account for, system, computer program product and/or method has advantage. Such advantage can be an error mitigation approach employing less memory, less time and/or less computing power than current error mitigation approaches.

In one or more embodiments of the above system, computer program product and/or method, the computation component can calculate the less than a full set of assignment matrix elements employing data from observed bitstrings. An advantage of such systems, computer program products and/or methods can be a direct reduction in memory employed, time taken and/or power used to perform the respective error mitigation. That is, even employing current supercomputers, current error mitigation approaches can only be conducted relative to a limited bitstring quantity and/or qubit count. This can be due at least in part to a quantity of memory that can currently be infeasible.

In one or more other embodiments of the above system, computer program product and/or method, the computation component can perform the error mitigation without constructing an assignment matrix. An advantage of such systems, computer program products and/or methods can be a direct reduction in memory employed, time taken and/or computing power used to perform the respective error mitigation. That is, even employing current supercomputers, current error mitigation approaches can only be conducted relative to a limited bitstring quantity and/or qubit count. This can be due at least in part to a quantity of memory that can currently be infeasible.

Additionally and/or alternatively, in one or more embodiments of the above systems, computer program products and/or methods, a computation component can perform error mitigation employing less than a full set of assignment matrix (A-matrix) elements that are calculated employing only data from observed bitstrings from one or more qubits.

An advantage of such system, computer program product and/or method can be a scalable and/or matrix-free approach to error mitigation that can account for increased bitstring quantity. Relative to a quantum system, such scalable and/or matrix-free approach to error mitigation can account for increased qubit count above that which is feasible using current error mitigation approaches. Furthermore, even relative to lower bitstring quantities and/or lower qubit count, for which current error mitigation approaches can be able to account for, such system, computer program product and/or method can provide advantage. Such advantage can be an error mitigation approach employing less memory, less time and/or less computing power than current error mitigation approaches. That is, even employing current supercomputers, current error mitigation approaches can only be conducted relative to a limited bitstring quantity and/or qubit count. This can be due at least in part to a quantity of memory that can currently be infeasible.

Additionally and/or alternatively, in one or more embodiments of the above systems, computer program products and/or methods, a computation component can perform error mitigation employing an iterative solver using a truncated set of assignment matrix (A-matrix) elements as the initial input set for the iterative solver.

An advantage of such system, computer program product and/or method can be a scalable and/or matrix-free approach to error mitigation that can account for increased bitstring quantity, and relative to a quantum system, can account for increased qubit count above that which is feasible using current error mitigation approaches. Furthermore, even relative to lower bitstring quantities and/or lower qubit count for which current error mitigation approaches can account for, a further advantage of such system, computer program product and/or method can be an error mitigation approach employing less memory, less time, and/or less computing power than the current error mitigation approaches. That is, even employing current supercomputers, current error mitigation approaches can only be conducted relative to a limited bitstring quantity and/or qubit count. This can be due at least in part to a quantity of memory that can be currently infeasible.

### DESCRIPTION OF THE DRAWINGS

FIG. 1 illustrates a block diagram of an example, non-limiting system that can facilitate error mitigation, in accordance with one or more embodiments described herein.

FIG. 2 illustrates another block diagram of an example, non-limiting system that can facilitate error mitigation, in accordance with one or more embodiments described herein.

FIG. 3 illustrates yet another block diagram of an example, non-limiting system that can facilitate error mitigation, in accordance with one or more embodiments described herein.

FIG. 4 illustrates still another block diagram of an example, non-limiting system that can facilitate error mitigation, in accordance with one or more embodiments described herein.

FIG. 5 illustrates a graph of ideal counts data graphed against noisy counts data that can be accounted for employing error mitigation, in accordance with one or more embodiments described herein.

FIG. 6 provides a depiction of full assignment matrix.

FIG. 7 illustrates a full assignment matrix for noisy outcomes of an operation on eight qubits and a truncated assignment matrix formed from the full assignment matrix.

FIG. 8 illustrates a trio of graphs comparing expectation values relative to data output from a twelve qubit operation as provided by three approaches. Illustrated are expectation values graphed against number of occurrences for the raw noisy data output, for data mitigated via a full tensored method, and for data mitigated by an error mitigation in accordance with one or more embodiments described herein.

FIG. 9 illustrates a flow diagram of an example, non-limiting computer-implemented method that can facilitate error mitigation, in accordance with one or more embodiments described herein.

FIG. 10 illustrates a continuation of the flow diagram of FIG. 9, of an example, non-limiting computer-implemented method that can facilitate error mitigation, in accordance with one or more embodiments described herein.

FIG. 11 illustrates another continuation of the flow diagram of FIG. 9, of an example, non-limiting computer-implemented method that can facilitate error mitigation, in accordance with one or more embodiments described herein.

FIG. 12 illustrates a block diagram of an example, non-limiting operating environment in which one or more embodiments described herein can be facilitated.

FIG. 13 illustrates a block diagram of an example, non-limiting cloud computing environment in accordance with one or more embodiments described herein.

FIG. 14 illustrates a block diagram of a plurality of example, non-limiting abstraction model layers, in accordance with one or more embodiments described herein.

### DETAILED DESCRIPTION

The following detailed description is merely illustrative and is not intended to limit embodiments, application and/or uses of embodiments. Furthermore, there is no intention to be bound by any expressed and/or implied information presented in the preceding Background and/or Summary sections, and/or in this Detailed Description section.

To account for one or more errors in quantum computing, such as readout measurement error, error mitigation techniques can be applied, such as by combining outcomes of multiple quantum program experiments (e.g., multiple runs of a quantum program) to thereby attempt to cancel contribution of noise, such as to a quantity of interest. One error mitigation approach known to those of skill in the art can be to compute (e.g., calculate) an assignment matrix (A-matrix) for noisy counts data output by a quantum system. It will be appreciated that an assignment matrix can also be referred to as a transition matrix (T-matrix). The inverse of the A-matrix can be applied to obtain an estimate of the ideal probability or quasi-probability vector for the one or more qubits employed in the respective quantum computing experiments. An assignment matrix probabilistically maps a given ideal measurement outcome (e.g., bitstring) to an actual outcome (e.g., bitstring) that is observed in the noisy output. In an assignment matrix, the probabilities of the rows of each column sum to 1.

Employing the equation p_{noisy}=Ap_{ideal}, then Aᵢₙᵥp_{noisy}=p_{ideal}, where A is the A-matrix, Aᵢₙᵥ is the inverse of the A-matrix, p_{noisy} is the probability vector that represents the noisy measurement outcomes actually measured, and p_{ideal} is the ideal probability vector and the answer being sought (e.g., absent errors, including noise-induced and gate errors).

Quantum computing experiments are evolving from use of a few qubits to employment of multi-qubit quantum algorithms that can address currently and/or practically relevant computational problems. However, the capabilities of current error measurement and/or mitigation techniques (e.g., quantum error measurement and/or mitigation techniques), such as described above, have not evolved commensurately to account for the increased qubit count of such multi-qubit quantum algorithms and/or quantum program experiments. For example, although an approach employing the A-matrix can be relatively easy to implement for quantum computing experiments employing small numbers of qubits, such an approach may not scale effectively for quantum computing experiments on a large-qubit-quantity scale. The large-qubit-quantity scale can include, e.g., a qubit quantity over about 20 qubits, over about 40 qubits, and/or even over 100 qubits.

Indeed, the A-matrix approach to error mitigation does not scale well with system size. Calculations for such can be performed numerous times in a quantum computing experiment, and thus can be calculated anew at each iteration. Each calculation anew can require not only a large quantity of memory, but also large amounts of time. For example, in an experiment employing 27 qubits, 2ⁿ elements, and thus 2⁵⁴ elements, would involve a need for enormous memory resources.

These and other deficiencies of current approaches for estimating quantum-computing readout results and/or for attempting to mitigate readout errors (e.g., quantum readout errors) can present inefficient, ineffective, inaccurate, non-scalable and/or otherwise undesirable options for estimation of quantum computing readout results and/or mitigation of readout errors.

Furthermore, such deficiencies can be exacerbated on a grander scale, such as where it can be desired to process many quantum-computing jobs for an entity, or even a plurality of entities during a time period, such as in a cloud-based arrangement. As used herein, the term “entity” can refer to a machine, device, smart device, component, hardware, software and/or human, and can be, e.g., a user entity or an administrator entity, for instance. A quantum job can include the execution of one or more quantum programs, and a desire to execute a large quantity of quantum jobs quickly can implicate a desire for maximizing system usage and minimizing measurement time, memory and/or energy usage, for example.

In view of the aforementioned one or more problems with current approaches to current error mitigation, the inventors have observed that it can be desirable to provide a new error mitigation approach. For example, it can be desirable to provide a new error mitigation approach that can be scalable for a larger quantity of qubits, where employed relative to measurement data from a quantum system. To such end, the described subject matter can employ various techniques that can provide a scalable and/or matrix-free error mitigation approach. The described subject matter also can, in one or more embodiments, improve (e.g., enhance, optimize and/or reduce) the execution time and/or quality for performing error mitigation relative to one or more quantum jobs. In one or more cases, one or more embodiments described herein can allow for increased scaling of execution of one or more quantum jobs in view of increased execution time and/or execution quality.

It will be appreciated that the described subject matter can be applicable to classical and/or quantum error mitigation. That is, as will be described below, a truncated set of A-matrix elements can be computed employing bitstring data from bit measurements, qubit measurements and/or other measurements. With respect to qubit measurements, the various techniques described herein can be applicable in the fields of quantum teleportation, measurement-based computation and/or quantum error correction.

One or more of these embodiments are now described with reference to the figures, where like referenced numerals are used to refer to like elements throughout. In the following description, for purposes of explanation, numerous specific details are set forth in order to provide a more thorough understanding of the one or more embodiments. It is evident in one or more cases, however, that the one or more embodiments can be practiced without these specific details.

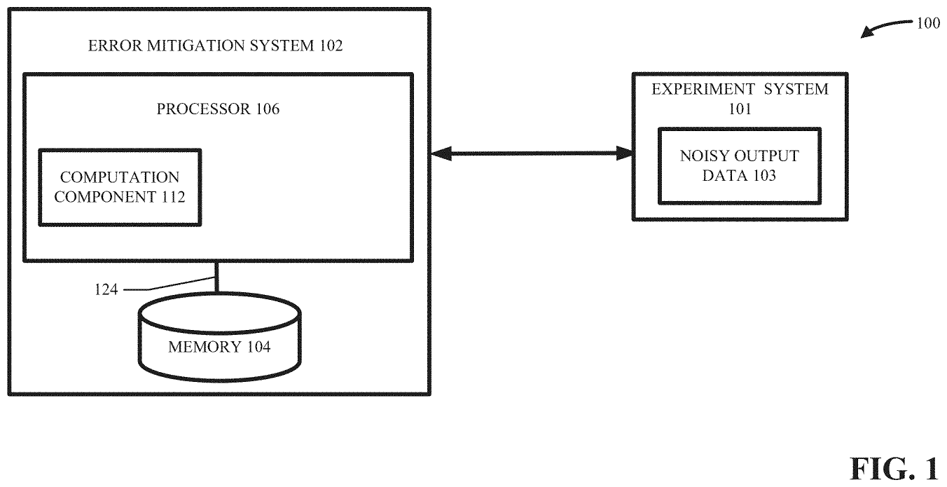

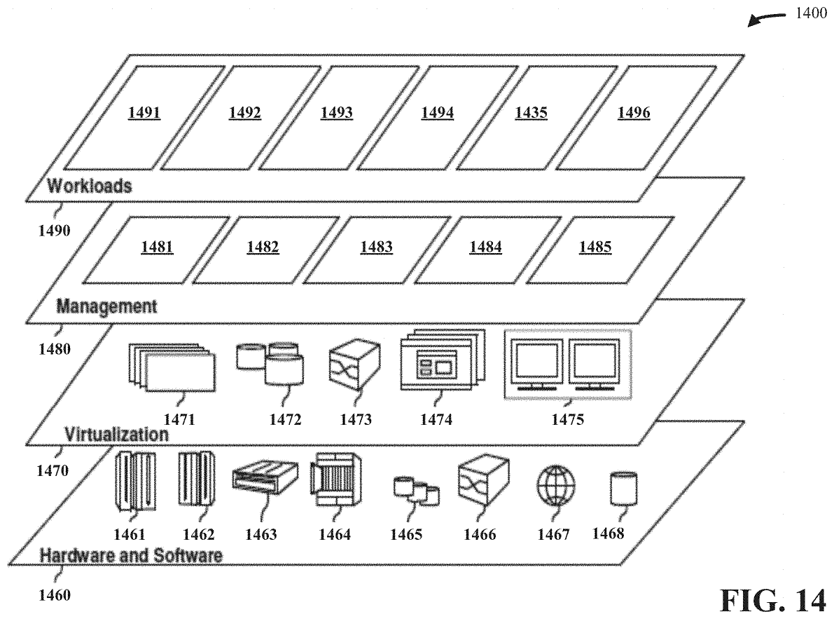

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems 100, 200, 300 and/or 400 illustrated at FIGS. 1, 2, 3 and/or 4, and/or systems thereof, can further comprise one or more computer and/or computing-based elements described herein with reference to an operating environment, such as the operating environment 1400 illustrated at FIG. 14. In one or more described embodiments, computer and/or computing-based elements can be used in connection with implementing one or more of the systems, devices, components and/or computer-implemented operations shown and/or described in connection with FIGS. 1, 2, 3 and/or 4 and/or with other figures described herein.

Turning first to FIG. 1, one or more embodiments described herein can include one or more systems, computer-implemented methods, apparatuses and/or computer program products that can facilitate error mitigation of noisy data, such as arising from one or more measurement errors. For example, FIG. 1 illustrates a block diagram of an example, non-limiting system 100 that can facilitate error mitigation relative to a scalable, such as a large, quantity of bitstrings and/or quantity of qubits employed to provide noisy output data to be error mitigated.

As illustrated, the non-limiting system 100 can comprise an experiment system 101. The experiment system 101 can comprise one or more components for operating an experiment and outputting noisy output data 103 (e.g., raw measurement data). The output data can be referred to as noisy in view of, for example, one or more experiment-based errors and/or measurement errors.

The experiment system 101 can include, for example, any suitable devices including one or more computing device(s) that can enable carrying out a measurement, receiving measurement data, operating an experiment, conducting experiments, and/or executing algorithms that yield data. As used herein, the one or more computing device(s) can be and/or can include one or more of a general-purpose computer, a special-purpose computer, a quantum computing device (e.g., a quantum computer), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet-enabled phone and/or another type of device. In one or more embodiments, the experiment system 101 can be associated with, for example, accessible via, a cloud computing environment.

Although not shown, the experiment system 101 can include a respective memory and/or processor. In the illustrated embodiment, the non-limiting system 100 includes the experiment system 101. Alternatively, the experiment system 101 can be external to, but accessible by, the non-limiting system 100. Alternatively, the error mitigation system 102 can include one or more components that can perform one or more processes performed by the experiment system 101.

The non-limiting system 100 can comprise the error mitigation system 102, which can be associated with, for example, accessible via, a cloud computing environment. The error mitigation system 102 can comprise one or more components, such as a memory 104, processor 106, bus 124 and/or computation component 112. Generally, error mitigation system 102, and thus non-limiting system 100, can facilitate error mitigation of the noisy output data 103.

The computation component 112 can perform error mitigation employing less than a full set of A-matrix elements. The less than a full set of A-matrix elements can have been computed by the error mitigation system 102 and/or the experiment system 101.

Accordingly, the one or more processes to be performed by the error mitigation system 102 can provide error mitigation that can account for increased bitstring quantity. Relative to a quantum system, the error mitigation system 102 can account for increased qubit count above that which is feasible using current error mitigation approaches. This can be at least in part because a full A-matrix and/or a full set of A-matrix elements are not computed. Furthermore, even relative to lower bitstring quantities and/or lower qubit count for which current error mitigation approaches can be able to account for, the one or more process to be performed by the error mitigation system 102 can have advantage. Such advantage can be an error mitigation approach employing less memory, less time, and/or less computing power than the current error mitigation approaches.

It also will be appreciated that operation of the error mitigation system 102 is not limited to computing a single error mitigation at a time. Rather, use of the error mitigation system 102 itself can be scalable, such as where the error mitigation system 102 can perform at least one error mitigation at least partially in parallel at a same time with another. This scalability, at least in part, can be provided due to the use of less than a full set of A-matrix elements, thereby employing less system memory, computing power and/or computation time.

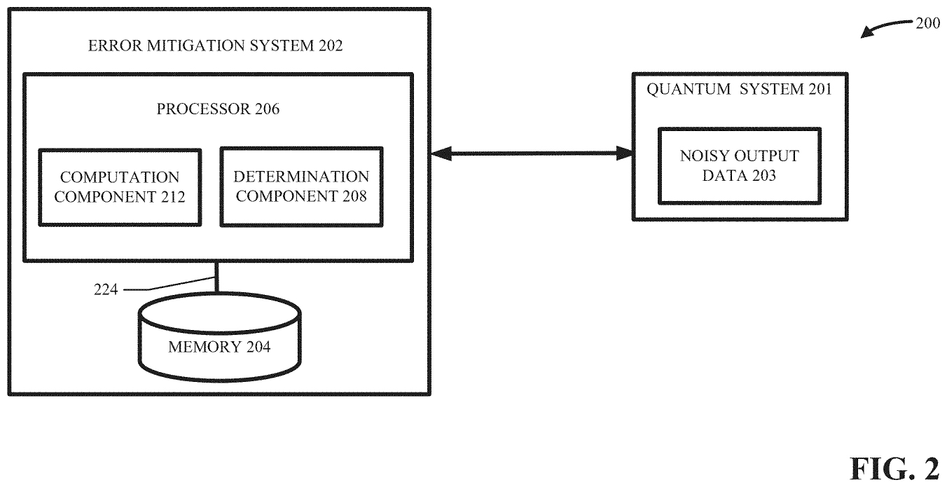

Looking now to FIG. 2, one or more additional embodiments described herein can include one or more systems, computer-implemented methods, apparatuses and/or computer program products that also can facilitate error mitigation. For example, FIG. 2 illustrates a block diagram of an example, non-limiting system 200 that can facilitate error mitigation relative in a scalable fashion, such as applicable to a large quantity of bitstrings and/or qubits that can provide noisy output data to be error mitigated.

As illustrated, the non-limiting system 200 can comprise a quantum system 201 and a classical system, such as an error mitigation system 202. That is, in one or more embodiments, the non-limiting system 200 can be a hybrid system. In one or more other embodiments, the quantum system 201 can be separate from, but function in combination with, the non-limiting system 200.

The illustrated quantum system 201 (e.g., quantum computer system, superconducting quantum computer system and/or the like) can be associated with, for example, accessible via, a cloud computing system. The quantum system 201 can employ quantum algorithms and/or quantum circuitry, including computing components and/or devices, to perform quantum operations and/or functions on input data to produce results that can be output to an entity. One or more components can be comprised by the quantum system 201, the output of which can comprise noisy output data 203 (e.g., raw qubit measurement data). The output data can be referred to as noisy in view of one or more experiment-based errors (e.g., gate-based errors) and/or measurement errors.

Although not shown, the quantum system 201 can include a respective memory and/or quantum processor. In one or more embodiments, the quantum system 201 can be associated with, such as accessible via, a cloud computing environment.

In the illustrated embodiment, the non-limiting system 200 includes the quantum system 201. Alternatively, the quantum system 201 can be external to, but accessible by, the non-limiting system 200. Alternatively, the error mitigation system 202 can include one or more components that can perform one or more processes performed by the quantum system 201.

The non-limiting system 200 can comprise the error mitigation system 202, which can be associated with, such as accessible via, a cloud computing environment. The error mitigation system 202 can comprise one or more components, such as a memory 204, processor 206, bus 224, determination component 208 and/or computation component 212. Generally, error mitigation system 202, and thus non-limiting system 200, can facilitate error mitigation of the noisy output data 203.

The determination component 208 can obtain, from the quantum system 201, the noisy measurement data comprising observed bitstring data.

The computation component 212 can perform error mitigation employing less than a full set of assignment matrix (A-matrix) elements that are computed employing only data from the observed bitstrings, such as from one or more qubits of the quantum system 201.

Accordingly, the one or more processes to be performed by the error mitigation system 202 can provide error mitigation for increased qubit count above that which is feasible using current error mitigation approaches. This can be at least in part because a full A-matrix and/or a full set of A-matrix elements need not be computed. error mitigation. In addition, a further advantage of the one or more process to be performed by the error mitigation system 202 can include an error mitigation approach employing less memory, time, and/or computing power than current error mitigation approaches.

It also will be appreciated that operation of the error mitigation system 202 is not limited to computing a single error mitigation at a time. Rather, use of the error mitigation system 202 itself can be scalable, such as where the error mitigation system 202 can perform at least one error mitigation at least partially in parallel at a same time with another. This scalability, at least in part, can be provided due to the use of less than a full set of A-matrix elements, thereby employing less system memory, computing power and/or computation time.

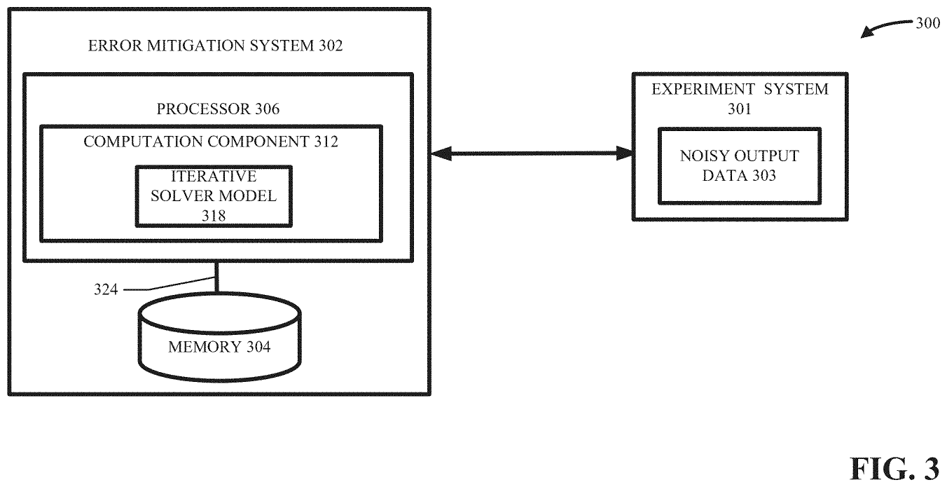

Turning next to FIG. 3, one or more embodiments described herein can include one or more systems, computer-implemented methods, apparatuses and/or computer program products that can facilitate error mitigation. For example, FIG. 3 illustrates a block diagram of an example, non-limiting system 300 that can facilitate error mitigation relative to a scalable, such as a large, quantity of bitstrings and/or quantity of qubits employed to provide noisy output data to be error mitigated.

As illustrated, the non-limiting system 300 can comprise an experiment system 301. The experiment system 301 can comprise one or more components for operating an experiment and outputting noisy output data 303 (e.g., raw measurement data). The output data can be referred to as noisy in view of one or more experiment-based errors and/or measurement errors.

The experiment system 301 can include, for example, any suitable devices including one or more computing device(s) that can enable carrying out a measurement, receiving measurement data, operating an experiment, conducting experiments, and/or executing algorithms that yield data. As used herein, the one or more computing device(s) can be and/or can include one or more of a general-purpose computer, a special-purpose computer, a quantum computing device (e.g., a quantum computer), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet-enabled phone and/or another type of device.

Although not shown, the experiment system 301 can include a respective memory and/or processor.

In the illustrated embodiment, the non-limiting system 300 includes the experiment system 301. Alternatively, the experiment system 301 can be external to, but accessible by, the non-limiting system 300. Alternatively, the error mitigation system 302 can include one or more components that can perform one or more processes performed by the experiment system 301. In one or more embodiments, the experiment system 301 can be associated with, for example, accessible via, a cloud computing environment.

The non-limiting system 300 can comprise the error mitigation system 302, which can be associated with, for example, accessible via, a cloud computing environment. The error mitigation system 302 can comprise one or more components, such as a memory 304, processor 306, bus 324 and/or computation component 312. Generally, error mitigation system 302, and thus non-limiting system 300, can facilitate error mitigation of the noisy output data 303.

The computation component 312 can perform error mitigation employing an iterative solver using a truncated set of assignment matrix (A-matrix) elements as the initial input set for the iterative solver. The iterative solver can be provided by, comprised by and/or operated by an iterative solver model 318. As shown, the iterative solver model 318 can be comprised by the computation component 312. In other embodiments, the iterative solver model 318 can be separate from the computation component 312.

Accordingly, the one or more processes to be performed by the error mitigation system 302 can provide error mitigation that can account for increased qubit count above that which is feasible using current error mitigation approaches. This can be at least in part because only a truncated set of A-matrix elements, and not a full A-matrix and/or a full set of A-matrix elements, are computed. error mitigation. In addition, a further advantage of the one or more process to be performed by the error mitigation system 302 can include an error mitigation approach employing less memory, time, and/or computing power than current error mitigation approaches. error mitigation

It also will be appreciated that operation of the error mitigation system 302 is not limited to computing a single error mitigation at a time. Rather, use of the error mitigation system 302 itself can be scalable, such as where the error mitigation system 302 can perform at least one error mitigation at least partially in parallel at a same time with another. This scalability, at least in part, can be provided due to the use of less than a full set of A-matrix elements, thereby employing less system memory and/or power and/or less computation time.

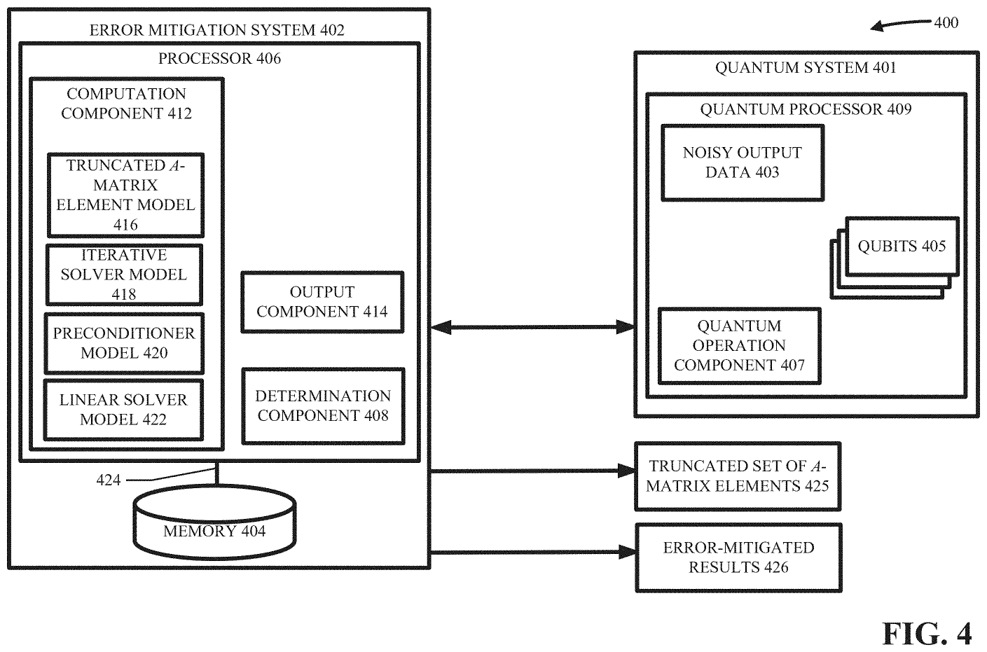

Turning next to FIG. 4, the figure illustrates a block diagram of an example, non-limiting system 400 that can facilitate error mitigation in accordance with one or more embodiments described herein. It will be appreciated that descriptions regarding components of the non-limiting systems 100, 200 and/or 300 can apply to one or more like components of the non-limiting system 400 and/or vice versa.

It further will be appreciated that the following description(s) refer(s) to the operation computation of a single error mitigation. However, it also will be appreciated that one or more of the processes described herein can be scalable. For example, as will be appreciated below, the error mitigation system 402 can perform at least one error mitigation at least partially in parallel at a same time with another. This scalability, at least in part, can be provided due to the use of less than a full set of A-matrix elements, thereby employing less system memory, computing power and/or computation time.

As illustrated, the non-limiting system 400 can comprise a quantum system 401 and a classical system, such as an error mitigation system 402. That is, in one or more embodiments, the non-limiting system 400 can be a hybrid system. In one or more other embodiments, the quantum system 401 can be separate from, but function in combination with, the non-limiting system 400.

The illustrated quantum system 401 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise circuitry for quantum bits (qubits), such as multi-bit qubits, other physical circuit level components, high level components and/or functions. The quantum circuitry can involve physical pulses that can be structured (e.g., arranged and/or designed) to perform desired quantum functions and/or computations on data (e.g., input data and/or intermediate data derived from input data) to produce one or more quantum results as an output. The quantum results can be responsive to the quantum job request and associated input data and can be based at least in part on the input data, quantum functions and/or quantum computations.

In one or more embodiments, the quantum system 401 can comprise one or more quantum components, such as a quantum operation component 407 and a quantum processor 409. The quantum operation component 407 can perform one or more quantum processes, calculations and/or measurements for operating one or more quantum circuits on one or more qubits 405. For example, the quantum operation component 407 can operate one or more qubit effectors, such as qubit oscillators, harmonic oscillators, pulse generators and/or the like to cause one or more pulses to stimulate and/or manipulate the state(s) of the one or more qubits 405 existing in the quantum system 401. In another example, the quantum operation component 407 can perform one or more measurements and provide the noisy output data 403.

The quantum processor 409 can be any suitable processor, such as being capable of controlling qubit generation and the like. The quantum processor 409 can generate one or more instructions for controlling the one or more processes of the quantum operation component 407.

Turning now to the classical portion of the non-limiting system 400, the error mitigation system 402 can comprise any type of component, machine, device, facility, apparatus and/or instrument that comprises a processor and/or can be capable of effective and/or operative communication with a wired and/or wireless network. All such embodiments are envisioned. For example, error mitigation system 402 can comprise a server device, computing device, general-purpose computer, special-purpose computer, quantum computing device (e.g., a quantum computer), tablet computing device, handheld device, server class computing machine and/or database, laptop computer, notebook computer, desktop computer, cell phone, smart phone, consumer appliance and/or instrumentation, industrial and/or commercial device, digital assistant, multimedia Internet enabled phone, multimedia players and/or another type of device.

In one or more embodiments, the error mitigation system 402 can comprise a processor 406 (e.g., computer processing unit, microprocessor, classical processor, quantum processor and/or like processor). In one or more embodiments, any component associated with error mitigation system 402, as described herein with or without reference to the one or more figures of the one or more embodiments, can comprise one or more computer and/or machine readable, writable and/or executable components and/or instructions that can be executed by processor 406 to facilitate performance of one or more processes defined by such component(s) and/or instruction(s). In one or more embodiments, the processor 406 can comprise the determination component 408, computation component 412 and/or output component 414.

In one or more embodiments, the error mitigation system 402 can comprise a computer-readable memory 404 that can be operably connected to the processor 406. The memory 404 can store computer-executable instructions that, upon execution by the processor 406, can cause the processor 406 and/or other components of the error mitigation system 402 (e.g., determination component 408, computation component 412 and/or output component 414) to perform one or more actions. In one or more embodiments, the memory 404 can store computer-executable components (e.g., determination component 408, computation component 412 and/or output component 414).

Error mitigation system 402 and/or a component thereof as described herein, can be communicatively, electrically, operatively, optically and/or otherwise coupled to one another via a bus 424 to perform functions of non-limiting system 400, error mitigation system 402 and/or any components thereof and/or coupled therewith. Bus 424 can comprise one or more of a memory bus, memory controller, peripheral bus, external bus, local bus, quantum bus and/or another type of bus that can employ one or more bus architectures. One or more of these examples of bus 424 can be employed to implement any one or more embodiments described herein.

In one or more embodiments, error mitigation system 402 can be coupled (e.g., communicatively, electrically, operatively, optically and/or like function) to one or more external systems, sources and/or devices (e.g., classical and/or quantum computing devices, communication devices and/or like devices), such as via a network. In one or more embodiments, one or more of the components of the non-limiting system 400 can reside in the cloud, and/or can reside locally in a local computing environment (e.g., at a desired location(s)).

In addition to the processor 406 and/or memory 404 described above, error mitigation system 402 can comprise one or more computer and/or machine readable, writable and/or executable components and/or instructions that, when executed by processor 406, can facilitate performance of one or more operations defined by such component(s) and/or instruction(s). For example, in one or more embodiments, error mitigation system 402 can comprise a determination component 408, computation component 412 and/or output component 414.

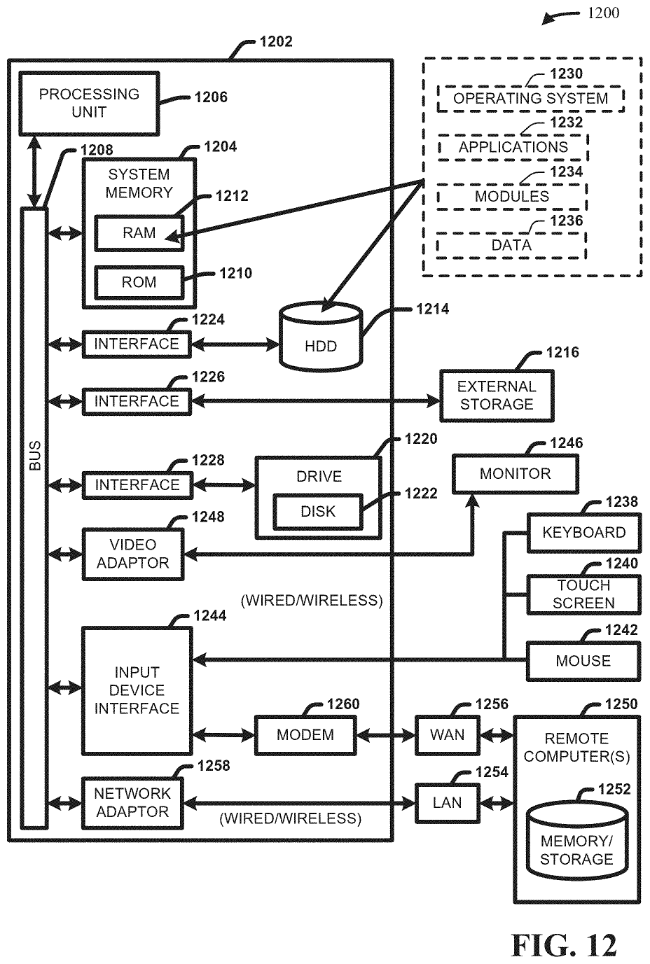

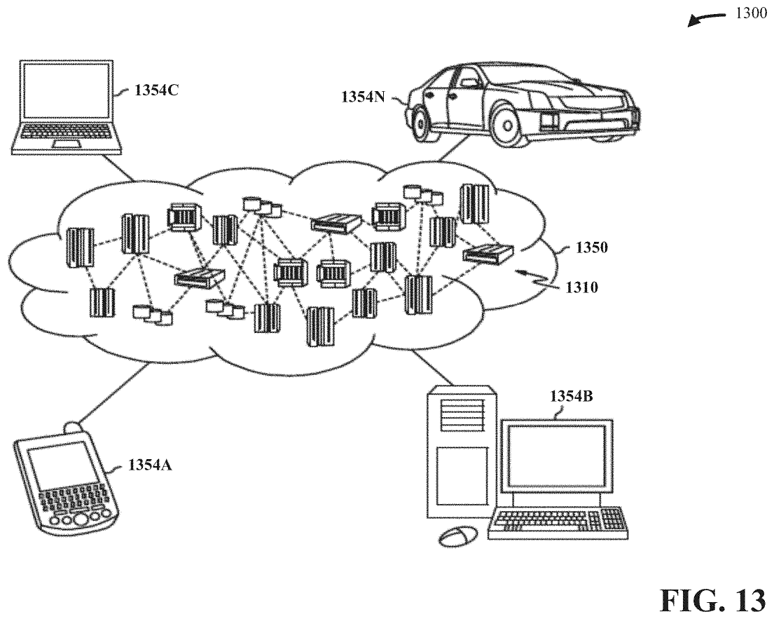

Turning now to the determination component 408, the noisy output data 403, which can comprise observed bitstring data, can be obtained from the quantum system 401 by the determination component 408. The determination component 408 can employ any one or more aspects of an operating environment, such as the operating environment 1200 illustrated at FIG. 12, to provide, such as to receive retrieve and/or otherwise obtain, the noisy output data 403. By way of a non-limiting example, the noisy output data 403 can be downloaded directly and/or indirectly from the quantum operation component 407, received from the memory/storage 1252 via the WAN 1256 and/or downloaded via the WAN 1256 from a node, such as a cloud computing node 1310 of a cloud computing environment 1350 (FIG. 13).

The computation component 412 generally can perform error mitigation employing less than a full set of A-matrix elements. The less than a full set of A-matrix elements can have been computed by the error mitigation system 402, as will be described below in detail.

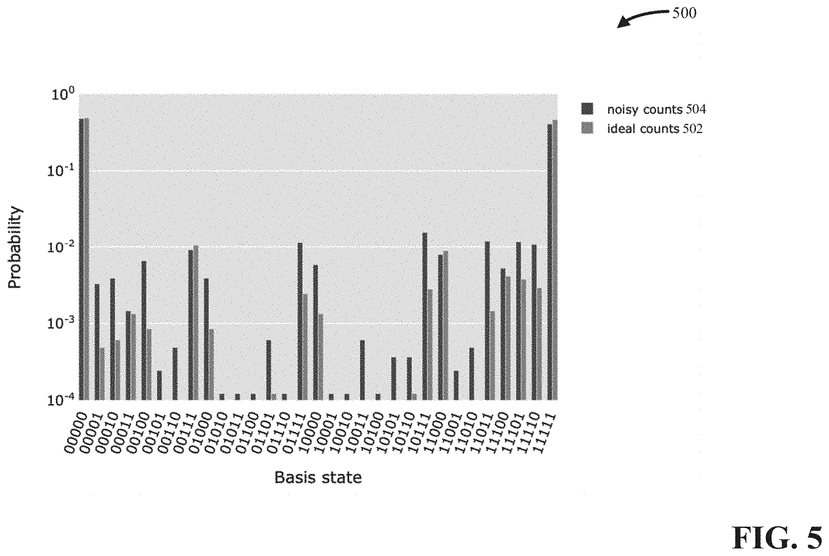

Turning briefly to FIG. 5, and also still to FIG. 4, FIG. 5 illustrates a graph of basis state measurements for a plurality of bitstrings of quantum measurement data. More particularly, illustrated are both the ideal counts data 502 (e.g., light bars) and the noisy counts data 504 (e.g., bold bars) graphed against probability of each of the basis states. The noisy counts data 504, which is the actual data output, is shifted from the ideal counts data 502, which is what could have been output if not for noise in the system, such as including gate-error noise and/or measurement error noise. The one or more embodiments described herein, such as including the non-limiting system 400, can provide one or more processes for mitigating the error noise, such as measurement error noise, via error mitigation. By employing various processes to be described below, the computation component 412 can help the non-limiting system achieve a shift in the noisy counts data 504 (e.g., akin to the noisy output data 403) closer to or at the ideal counts data 502.

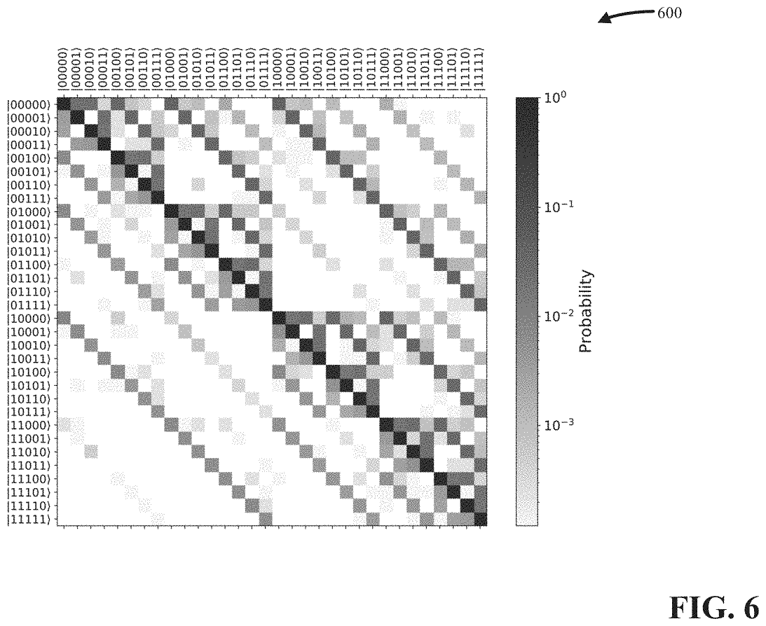

Turning next to FIG. 6, and also still to FIG. 4, the error mitigation processes computed by the computation component 412 are different from a conventional technique employing a full A-matrix. The A-matrix probabilistically maps a given ideal measurement outcome (e.g., bitstring) to an actual outcome (e.g., bitstring, such as the integers 00000-11111 at FIG. 6) that is observed in the noisy output. For example, as illustrated at FIG. 6, a full A-matrix can become large and cumbersome, if not outright infeasible, to work with, to construct and/or or to store data relative to when concerning large numbers of qubits, such as a quantity greater than 20 qubits.

Indeed, conventional error mitigation techniques can be infeasible to employ with noisy data output from large qubit quantities, such as above, for example, 20 qubits. This can be at least in part due to the infeasibility of constructing a full A-matrix. This can be because the calculation of an A-matrix in an experiment employing n qubits involves calculating 2ⁿ elements.

Instead, employing the computation component 412, and thus the error mitigation system 402, an entity can achieve error mitigation on a large quantity of and/or scalable data, such as relative to a large quantity of and/or scalable number of qubits. It is to be appreciated that the error mitigation processes computed by the computation component 412 can be scalable from measurements concerning one qubit to many qubits, such as hundreds of qubits and/or such as thousands of qubits, and thus also can function relative to smaller amounts of measurement data from small qubit numbers.

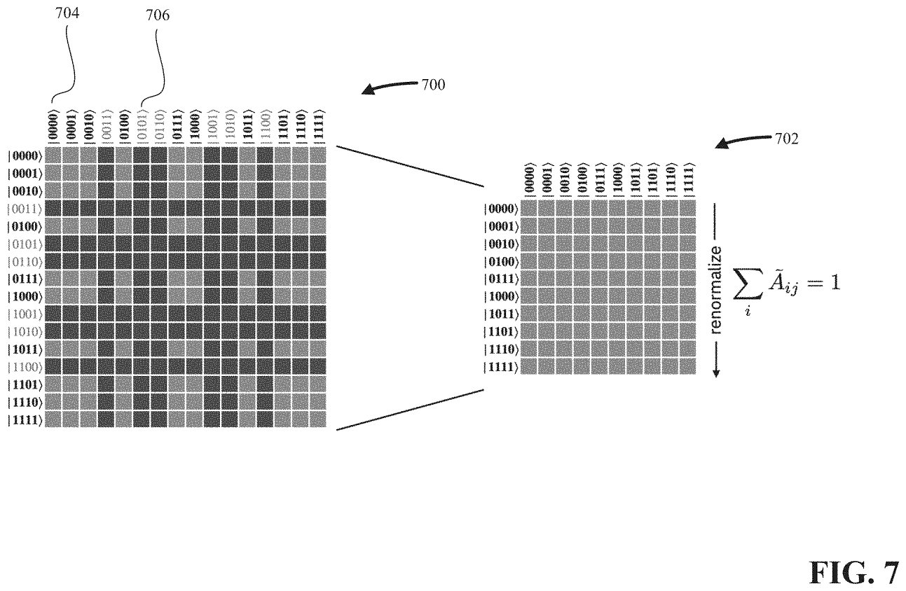

Turning now to FIG. 7, and also still to FIG. 4, consider an assignment matrix (A-matrix) in view of the equation p_{noisy}=Ap_{ideal}, where A is the A-matrix, p_{noisy} is the probability vector that represents the noisy measurement outcomes actually measured, and p_{ideal} is the ideal probability vector and the answer being sought (e.g., absent errors, including noise-induced and gate errors). Solving for p_{ideal}, the equation can become Aᵢₙᵥp_{noisy}=p_{ideal}, where Aᵢₙᵥ is the inverse of the A-matrix. That is, solving for the A-matrix, or at least for the A-matrix elements in principle can provide output of one or more error-mitigated results 426.

However, rather than construct a full A-matrix and/or solve for a full set of A-matrix elements, the computation component 412 can employ one or more calculation models 416, 418, 420 and/or 422 to instead solve for less than a full set of A-matrix elements, such as a truncated set of A-matrix elements 425, and employ the truncated set of A-matrix elements 425 to solve for the one or more error-mitigated results 426. That is, the computation component 412 can generally employ a truncated A-matrix element model 416 to calculate a truncated set of A-matrix elements 425.

For example, while the computation component 412 does not construct either of a full A-matrix or truncated A-matrix, FIG. 7 illustrates both a full A-matrix 700 and a truncated A-matrix for purposes of explanation. That is, a full set of noisy output data 403 can be represented by a full A-matrix 700. The full A-matrix 700 can include both observable bitstrings (in bold, such as bitstring 704) and bitstrings that were not observed (in non-bold, such as bitstring 706). One purpose of the computation component 412 can be to truncate the number of A-matrix elements employed down to a truncated set of A-matrix elements 425, such as would be represented by the truncated A-matrix 702.

However, since it can be undesirable or infeasible to construct a full A-matrix (e.g., full A-matrix 700), such as due to available memory, usable memory, allowable quantity of bitstring integers, available processing power and/or available time, instead, the computation component 412 can employ a renormalization factor relative to one or more of the observed bitstrings (e.g., such as the observed bitstring 704). Indeed, the computation component 412 can employ a renormalization factor relative to each of the observed bitstrings. This is at least in part because, relative to the non-constructed truncated A-matrix, each of the columns of an A-matrix add to one. However, the truncation can remove one or more bitstrings, and thus can remove one or more probabilities. Thus, a non-renormalized column of a truncated A-matrix does not sum to one. Accordingly, a renormalization factor can be applied to again achieve column totals of the non-constructed truncated A-matrix each summing to one.

For example, each of the bitstrings in a column can be summed, and each element in the column can be divided by this sum to thereby rescale the column such that the truncated column once again sums to one. Again, it will be appreciated that the actual columns and/or truncated A-matrix need not be constructed. Rather, the observed values can be stored outside of a matrix, such as in a separate array, and the division can be completed matrix-free when employed.

A renormalization algorithm for employing the renormalization factor(s) can be employed by a truncated A-matrix element model 416. The renormalization algorithm can be comprised by the truncated A-matrix element model 416 and/or instead can be stored elsewhere and accessed by the truncated A-matrix element model 416. The truncated A-matrix element model 416 can be comprised by the computation component 412, as illustrated, and/or instead can be stored elsewhere and accessed by the computation component 412. The one or more renormalized bitstring elements output from the A-matrix element model employing the renormalization algorithm can be stored, such as temporarily, at the truncated A-matrix element model 416, at the computation component 412 and/or elsewhere. That is, the one or more renormalized bitstring elements instead can be accessed by the truncated A-matrix element model 416 and/or at the computation component 412 to be further employed by the truncated A-matrix element model 416 and/or at the computation component 412. In one or more embodiments, one or more bitstring elements can be renormalized where appropriate, rather than all collectively, such as where being employed by a linear solver or iterative solver, as will be described below.

Next, again employing the truncated A-matrix element model 416, the computation component 412 can apply a function evaluator (also herein referred to as a function eval) to calculate the truncated set of A-matrix elements 425 from the renormalized data. A function eval format can be comprised by the truncated A-matrix element model 416 and/or instead can be stored elsewhere and accessed by the truncated A-matrix element model 416. In one embodiment, a function eval, such as shown below at Equation 1, can be employed for one or more renormalized observable bitstring elements to thereby calculate a respective A-matrix element, and thus collectively to calculate the truncated set of A-matrix elements 425. Equation 1 can employ the noisy bitstring data (e.g., the observed bitstring data), and particularly can employ the row bits, column bits and calibration data (written as “cals” in Equation 1) relative to each respective observable bitstring. Accordingly, relative to Equation 1, the truncated set of A-matrix elements 425 includes a set of A[i,j]s.

As used herein, the calibration data (cals) can include one or more calibration factors, such as calibration matrices. For example, one or more calibration matrices can be employed per qubit employed in a quantum program experiment.

A[i,j]=f(row_bits,col_bits,cals) Equation 1:

It will be appreciated that restriction to those bitstrings observed, as opposed to a full 2¹¹ matrix, can provide a workable approach because measurement errors can transfer small amounts of probability from one or more bitstrings in an ideal count set to one or more counts in a noisy output set. That is, as one or more ideal bitstrings are nominally included in the noisy output set, error mitigation performed by one or more embodiments described herein can redistribute one or more of such probabilities among one or more bitstrings in the noisy output set, such as only in the noisy output set.

It also will be appreciated that storing the truncated set of A-matrix elements 425 (e.g., including the set of A[i,j]s) can use less memory than conventional approaches and thus for each use thereof, the calculations can be made anew, employing less memory than a high-memory matrix.

Upon computation of at least one or more of the A-matrix elements of the truncated set of A-matrix elements 425, the computation component 412, and/or an administrator entity, can make a selective decision as to how to further approach the solving of the error-mitigation problem.

Where the truncated set of A-matrix elements 425 employs a feasible and/or available amount of memory, the actual truncated A-matrix (e.g., such as a truncated A-matrix 702) can be constructed from the truncated set of A-matrix elements 425. An inverse of the truncated A-matrix can then be employed to solve for the error-mitigated results 426.

For example, in one or more embodiments, a linear solver, such as a lower-upper decomposition (LU decomposition) can be employed by a linear solver model 422. Generally, an LU decomposition of a matrix can be a factorization of a given square matrix into two triangular matrices, one upper and one lower, such that the product of these matrices gives the original matrix. The linear solver can be comprised by the linear solver model 422 and/or instead can be stored elsewhere and accessed by the linear solver model 422. The linear solver model 422 can be comprised by the computation component 412, as illustrated, and/or instead can be stored elsewhere and accessed by the computation component 412.

Additionally or alternatively, the computation component 412, and/or an administrator entity, can make a selective decision as to continue with a matrix-free computation and to thereby employ one or more iterative solver algorithms, such as via the iterative solver model 418. An iterative solver algorithm can be comprised by the iterative solver model 418 and/or instead can be stored elsewhere and accessed by the iterative solver model 418. The iterative solver model 418 can be comprised by the computation component 412, as illustrated, and/or instead can be stored elsewhere and accessed by the computation component 412. For example, an iterative solver algorithm can include and/or employ a generalized minimal residue (GMRES) method, biconjugate gradient stabilized (BICGSTAB) method, Jacobi method and/or the like. Such methods can solve a linear system of equations employing matrix-vector multiplication, and thus can admit a matrix-free formulation including computing the matrix elements A[i,j] absent explicit construction of the truncated A-matrix.

The iterative solver algorithm can be run one or more iterations, such as to achieve convergence. Convergence can be measured by the change in a solution vector from one iteration output from the iterative solver algorithm to the next (e.g., the vector norm of the difference between iterations). The truncated set of A-matrix elements 425 can be employed as an initial input set for a first iteration of the iterative solver algorithm.

Additionally or alternatively, such as prior to performing one or more iterations of the iterative solver, the computation component 412, and/or an administrator entity, can make a selective decision as to employ a preconditioner (e.g., a preconditioner algorithm) relative to the truncated set of A-matrix elements 425. A preconditioner algorithm can be comprised by the preconditioner model 420 and/or instead can be stored elsewhere and accessed by the preconditioner model 420. The preconditioner model 420 can be comprised by the computation component 412, as illustrated, and/or instead can be stored elsewhere and accessed by the computation component 412. For example, a Jacobi preconditioner can comprise an array of elements formed by taking the 1/Aᵢᵢ, where Aii are the diagonal elements of the truncated A-matrix. This array can be employed in that the A-matrix has the largest elements along the diagonal. The aim of a Jacobi preconditioner can be to make a condition number of the truncated A-matrix closer to one, thus enabling the number of iterative solver iterations employed to be reduced.

Further, it will be appreciated that the error mitigation provided by the error mitigation system 402 can function with noisy output data 403 that has varying levels of error, such as including measurement error. For example, the error mitigation system 402 can mitigate noisy output data 403 having error in a range of about 0% to about 10%, in a range of about 0% to about 20%, in a range of about 0% to about 30%, in a range of about 0% to about 50% or higher than these ranges. Likewise, the error mitigation provided by the error mitigation system 402 can function with noisy output data 403 collected and/or combined from varying numbers of experiment iterations. However, it will be appreciated that errors, such as measurement errors, can move one or more portions of data to one or more incorrect bitstreams in such collected and/or combined noisy output data 403 where the collected and/or combined noisy output data 403 is provided from a low or finite sample count. Nonetheless, the error mitigation provided by the error mitigation system 402 can function with such low-sample limits.

The error mitigation system 402 also can comprise an output component 414. One or more error-mitigated results 426 can be output from the non-limiting system 400 via the output component 414. The one or more error-mitigated results 426 can comprise and/or can be based at least in part on the truncated set of A-matrix elements 425, and/or can be responsive to a quantum job request from a requesting entity.

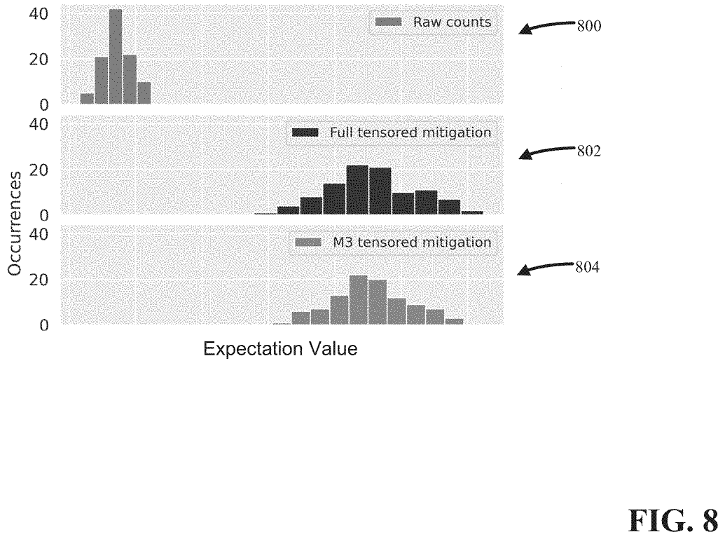

Turning next to FIG. 8, and also still to FIG. 4, a trio of graphs is illustrated comparing expectation values relative to data output from a twelve-qubit operation as provided by three approaches. Illustrated are expectation values graphed against number of occurrences for the raw noisy data output at graph 800, for data mitigated via a full tensored method at graph 802, and for data mitigated by an error mitigation approach in accordance with one or more embodiments described herein at graph 804. As illustrated, raw noisy data output can shift the expectation value. Also as illustrated, the full tensored method at graph 802 and the error mitigation provided in accordance with one or more embodiments described herein at graph 804 each provide similar expectation values. It will be appreciated that as qubit count, and/or classical bit count, increases, it can be infeasible to perform a full tensored method, and thus the error mitigation method provided in accordance with one or more embodiments described herein has increasing advantage due to its scalability.

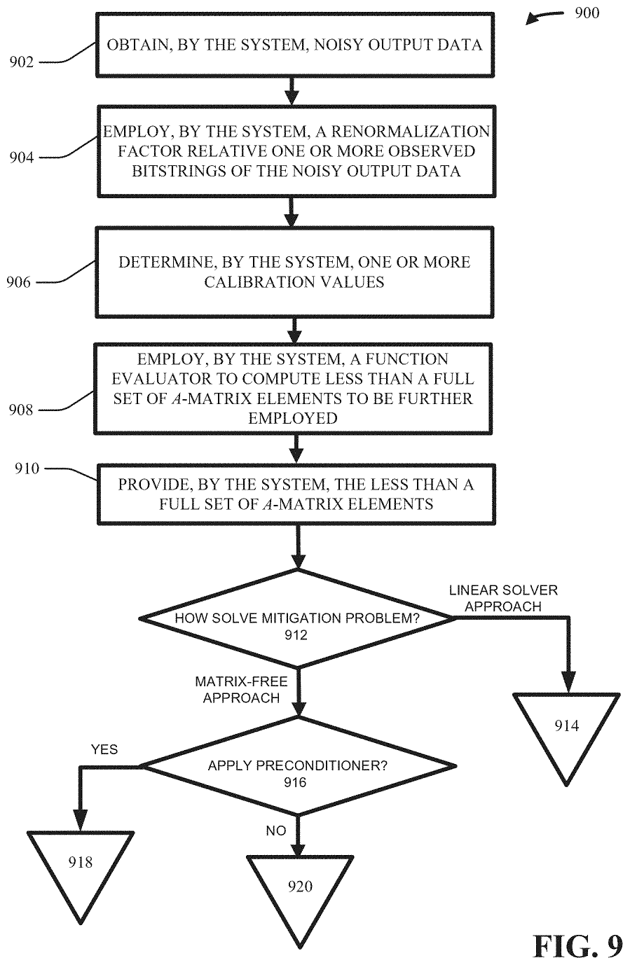

Turning now to FIGS. 9-11, these figures together illustrate a flow diagram of an example, non-limiting computer-implemented method 900 that can facilitate error mitigation, in accordance with one or more embodiments described herein with respect to the non-limiting system 400. It will be appreciated that while the computer-implemented method 900 is described relative to the non-limiting system 400, the computer-implemented method 900 can be applicable also to the non-limiting systems 100, 200 and/or 300. Repetitive description of like elements and/or processes employed in respective embodiments is omitted for sake of brevity.

Looking first to 902 at FIG. 9, the computer-implemented method 900 can comprise obtaining, by a system (e.g., via non-limiting system 400, error mitigation system 402 and/or determination component 408) operatively coupled to a processor (e.g., processor 406, a quantum processor and/or like processor) a set of noisy output data (e.g., noisy output data 403).

At 904, the computer-implemented method 900 can comprise employing, by the system (e.g., via non-limiting system 400, error mitigation system 402, computation component 412 and/or truncated A-matrix element model 416), a renormalization factor (e.g., from truncated A-matrix element model 416) relative to one or more observed bitstrings (e.g., akin to an observed bitstring 704) of the noisy output data (e.g., noisy output data 403).

At 906, the computer-implemented method 900 can comprise determining, by the system (e.g., via non-limiting system 400, error mitigation system 402, computation component 412 and/or truncated A-matrix element model 416), one or more calibration factors (e.g., cals).

At 908, the computer-implemented method 900 can comprise employing, by the system (e.g., via non-limiting system 400, error mitigation system 402, computation component 412 and/or truncated A-matrix element model 416), a function evaluator (e.g., from the truncated A-matrix element model 416) to compute less than a full set of A-matrix elements (e.g., truncated set of A-matrix elements 425) to be further employed. The function evaluator (e.g., from the truncated A-matrix element model 416) can employ the one or more calibration factors.

At 910, the computer-implemented method 900 can comprise providing, by the system (e.g., via non-limiting system 400, error mitigation system 402, computation component 412 and/or truncated A-matrix element model 416), the computed less than a full set of A-matrix elements (e.g., truncated set of A-matrix elements 425).

At 912, the computer-implemented method 900 can comprise deciding, by the system (e.g., via non-limiting system 400, error mitigation system 402, computation component 412 and/or administrator entity), how to further solve the mitigation problem. The computer-implemented method 900 can take a linear solver approach and proceed to continuation triangle 914 and/or the computer-implemented method 900 can continue a matrix-free approach and proceed to decision block 916.

At 916, the computer-implemented method 900 can comprise deciding, by the system (e.g., via non-limiting system 400, error mitigation system 402, computation component 412 and/or administrator entity), whether or not to apply a preconditioner (e.g., such as from a preconditioner model 420) to the less than a full set of A-matrix elements (e.g., truncated set of A-matrix elements 425). Where the answer is “yes”, the computer-implemented method 900 can proceed to continuation triangle 918. Where the answer is “no”, the computer-implemented method 900 can proceed to continuation triangle 920.

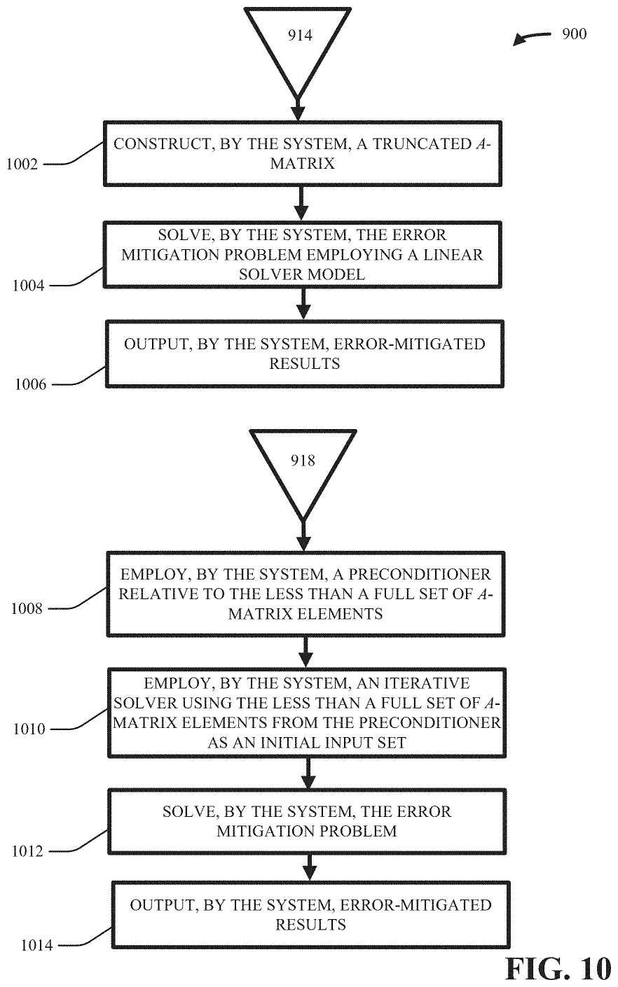

Turning now to FIG. 10, this figure illustrates a pair of extensions of the computer-implemented method 900 of FIG. 9, and particularly illustrates aspects that can occur at continuation triangles 914 and 918 of FIG. 9.

At 1002, the computer-implemented method 900 can continue from the continuation triangle 914 and can comprise constructing, by the system (e.g., via non-limiting system 400, error mitigation system 402, computation component 412 and/or linear solver model 422) a truncated A-matrix (e.g., akin to the truncated A-matrix 702).

At 1004, the computer-implemented method 900 can comprise solving, by the system (e.g., via non-limiting system 400, error mitigation system 402, computation component 412 and/or linear solver model 422) the mitigation problem employing a linear solver model (e.g., linear solver model 422).

At 1006, the computer-implemented method 900 can comprise outputting, by the system (e.g., via non-limiting system 400, error mitigation system 402 and/or output component 414) error-mitigated results (e.g., error-mitigated results 426).

At 1008, the computer-implemented method 900 can continue from the continuation triangle 918 and can comprise employing, by the system (e.g., via non-limiting system 400, error mitigation system 402, computation component 412 and/or preconditioner model 420) a preconditioner relative to the less than a full set of A-matrix elements (e.g., truncated set of A-matrix elements 425).

At 1010, the computer-implemented method 900 can comprise employing, by the system (e.g., via non-limiting system 400, error mitigation system 402, computation component 412 and/or iterative solver model 418) an iterative solver using the less than a full set of A-matrix elements (e.g., truncated set of A-matrix elements 425) and/or the less than a full set of A-matrix elements (e.g., truncated set of A-matrix elements 425) from the preconditioner or preconditioner model (e.g., preconditioner model 420) as an initial input set for the iterative solver.

At 1012, the computer-implemented method 900 can comprise solving, by the system (e.g., via non-limiting system 400, error mitigation system 402, computation component 412 and/or iterative solver model 418), the error mitigation problem. The solving can include performing one or more consecutive iterations of the iterative solver.

At 1014, the computer-implemented method 900 can comprise outputting, by the system (e.g., via non-limiting system 400, error mitigation system 402 and/or output component 414) error-mitigated results (e.g., error-mitigated results 426).

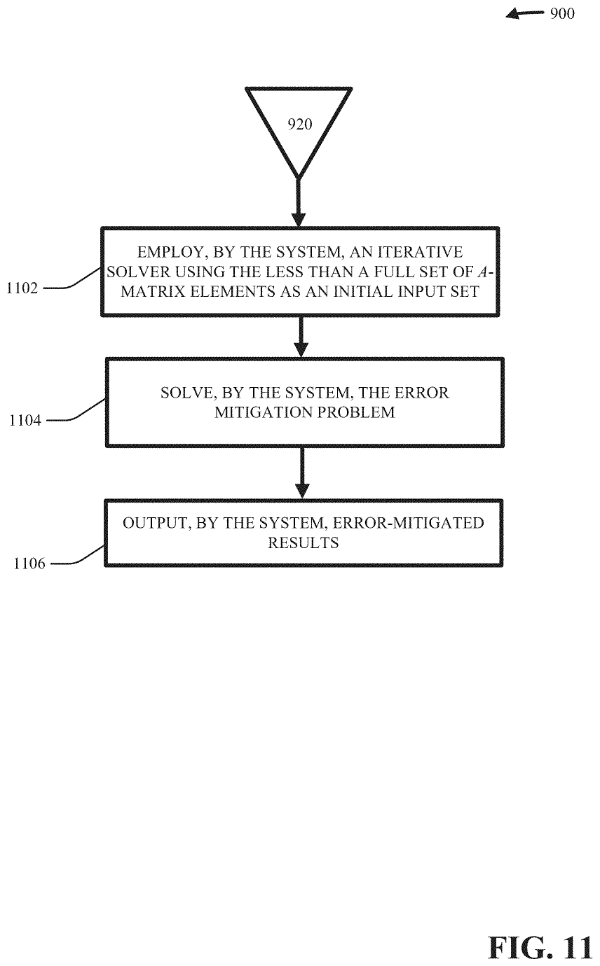

Turning now to FIG. 11, this figure illustrates an extension of the computer-implemented method 900 of FIG. 9, and particularly illustrates aspects that can occur at the continuation triangle 920 of FIG. 9.

At 1102, the computer-implemented method 900 can comprise continuing from the continuation triangle 920 and employing, by the system (e.g., via non-limiting system 400, error mitigation system 402, computation component 412 and/or iterative solver model 418) an iterative solver using the less than a full set of A-matrix elements (e.g., truncated set of A-matrix elements 425) as an initial input set for the iterative solver.

At 1104, the computer-implemented method 900 can comprise solving, by the system (e.g., via non-limiting system 400, error mitigation system 402, computation component 412 and/or iterative solver model 418) the error mitigation problem. The solving can include performing one or more consecutive iterations of the iterative solver.

At 1106, the computer-implemented method 900 can comprise outputting, by the system (e.g., via non-limiting system 400, error mitigation system 402 and/or output component 414) error-mitigated results (e.g., error-mitigated results 426).

For simplicity of explanation, the computer-implemented methodologies provided herein are depicted and/or described as a series of acts. It is to be understood and appreciated that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented methodologies in accordance with the described subject matter. In addition, those skilled in the art will understand and appreciate that the computer-implemented methodologies could alternatively be represented as a series of interrelated states via a state diagram or events. Additionally, it should be further appreciated that the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any computer-readable device or storage media.

Turning now to the FIGS. 4-11 in combination, and still to the non-limiting system 400 and error mitigation system 402, one or more embodiments as described herein can provide a new approach driven by previously unincorporated computation of a truncated set of A-matrix elements, such as employing only data from observed bitstrings. For example, error mitigation system 402 and/or non-limiting system 400 can provide a new approach to quickly and/or automatically mitigate error from a scalable quantity of noisy output data 403. The noisy output data 403 can include classical-based or quantum-based data. Accordingly, the one or more processes to be performed by the error mitigation system 402 can provide error mitigation that can account for increased bitstring quantity. Relative to a quantum system, the one or more processes to be performed by the error mitigation system 402 can account for increased qubit count above that which is feasible using current error mitigation approaches. This can be at least in part because error mitigation according to one or more embodiments herein can be performed without computing a full A-matrix and/or a full set of A-matrix elements.

Error mitigation system 402 and/or non-limiting system 400 can provide technical improvements to one or more systems employing the error mitigation system 402. One technical improvement can include the ability to employ larger quantities of bits and/or qubits in classical and/or quantum experiments and to be capable (e.g., instead of being infeasible) to mitigate error from respective noisy output data. This can be in part due to the employment by the error mitigation approach of the error mitigation system 402 and/or non-limiting system 400 of less memory, less time, and/or less computing power than current error mitigation approaches.

Additionally and/or alternatively, another technical improvement can be such employment and or utilization of less memory, less time, and/or less computing power than the current error mitigation approaches. Indeed, an advantage of the one or more process to be performed by the error mitigation system 402 can be an enhanced (e.g., improved and/or optimized) execution of an error mitigation, such as comprising a direct reduction in memory employed, time taken and/or power used to perform the respective error mitigation, and/or to permit operation with qubit counts that would otherwise be infeasible.

Accordingly, the described subject matter, by employing the computation component 412 and/or error mitigation system 402, can create an improvement in speed of execution of jobs due to the use of less memory, less time, and/or less computing power. This can be as compared to traditional non-matrix-free error mitigation approaches, such as employing a linear solver. For example, relative to a hybrid classical/quantum non-limiting system 400, where there is high demand for execution of an increased quantity of quantum programs employing the quantum system 401, it can follow that use of the non-limiting system 400 (e.g., including the error mitigation system 402 and/or computation component 412) can facilitate scaled execution of quantum programs via scaled and/or matrix-free execution of associated error mitigations. That is, by reducing time, processing power and/or memory utilized and/or incurred during performance of one or more quantum programs, slower occurrence of decoherence of the one or more qubits employed can occur, and thus can allow for additional quantum programs to be executed on the qubits. This in turn can lead to a related reduction in provision of new qubits by a quantum system comprising the one or more qubits, and consequently, increased availability of processing capabilities of a quantum processor of a quantum system due, at least in part, to the decreased provision of new qubits.

A practical application of the error mitigation system 402 and/or non-limiting system 400 is that it can be implemented in one or more domains to enable scaled and/or matrix-free error mitigation. For example, the error mitigation system 402 can quickly and/or automatically mitigate error from a scalable quantity of noisy output data 403. The noisy output data 403 can include classical-based or quantum-based data. Further, use of the error mitigation system 402 itself can be scalable, such as where the error mitigation system 402 can perform at least one error mitigation at least partially in parallel at a same time with another.

Moreover, one or more embodiments described herein can control real-world devices based on the disclosed teachings. For example, one or more embodiments described herein can provide error mitigation of data provided by a real-world classical and/or quantum device, such as from operation of one or more programs and/or experiments operated on one or more real-world qubits.

While the one or more advantages described above have been described with reference to FIGS. 4-11 and the non-limiting system 400, it will be appreciated that one or more of the advantages described above also can be applicable to the non-limiting systems 100, 200 and/or 300.

Description now turns to that applicable to any one or more embodiments as described above with respect to FIGS. 1-11, with respect to any of non-limiting systems 100, 200, 300 and/or 400, and/or with respect to extensions and/or modifications thereof. The systems and/or devices have been (and/or will be further) described herein with respect to interaction between one or more components. It should be appreciated that such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

It is to be appreciated that one or more embodiments described herein are inherently and/or inextricably tied to computer technology and cannot be implemented outside of a hybrid classical/quantum computing environment. For example, one or more processes performed by one or more embodiments described herein can more efficiently, and even more feasibly, provide error mitigation as compared to current systems and/or techniques. Systems, computer-implemented methods and/or computer program products facilitating performance of these processes are of great utility in the field of quantum computation and cannot be equally practicably implemented in a sensible way outside of a computing environment.

It also is to be appreciated that one or more embodiments described herein can employ hardware and/or software to solve problems that are highly technical in nature (e.g., related to computing A-matrix elements, performing qubit measurement and/or computing iterations of data employ an iterative solver and/or preconditioner), that are not abstract, and that cannot be performed as a set of mental acts by a human. For example, a human, or even thousands of humans, cannot efficiently, accurately and/or effectively compute A-matrix elements, perform qubit measurement and/or compute iterations of data employing an iterative solver and/or preconditioner in the time that one or more embodiments described herein can facilitate this process. And, neither the human mind nor a human with pen and paper electronically compute A-matrix elements, perform qubit measurement and/or compute iterations of data employing an iterative solver and/or preconditioner as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing the one or more operations described herein.

Turning next to FIG. 12-14, to provide additional context for one or more embodiments described herein at FIGS. 1-11, FIGS. 12-14 are described in detail.

FIG. 12 and the following discussion are intended to provide a brief, general description of a suitable operating environment 1200 in which one or more embodiments described herein at FIGS. 1-11 can be implemented. For example, one or more components and/or other aspects of embodiments described herein can be implemented in and/or be associated with, such as accessible via, the operating environment 1200. Further, while one or more embodiments have been described above in the general context of computer-executable instructions that can run on one or more computers, those skilled in the art will recognize that one or more embodiments also can be implemented in combination with other program modules and/or as a combination of hardware and software.

Generally, program modules include routines, programs, components, data structures and/or the like, that perform particular tasks and/or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and/or the like, each of which can be operatively coupled to one or more associated devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data and/or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) and/or other optical disk storage, magnetic cassettes, magnetic tape, magnetic disk storage and/or other magnetic storage devices, solid state drives or other solid state storage devices and/or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory and/or computer-readable media that are not only propagating transitory signals per se.

Computer-readable storage media can be accessed by one or more local or remote computing devices, e.g., via access requests, queries and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, but not limitation, communication media can include wired media, such as a wired network, direct-wired connection and/or wireless media such as acoustic, RF, infrared and/or other wireless media.

With reference again to FIG. 12, the example operating environment 1200 for implementing one or more embodiments of the aspects described herein can include a computer 1202, the computer 1202 including a processing unit 1206, a system memory 1204 and/or a system bus 1208. It will be appreciated that any aspect of the system memory 1204 or processing unit 1206 can be applied to memories 104, 204, 304 and/or 404 and/or to processors 106, 206, 306 and/or 406, respectively of the non-limiting systems 100, 200, 300 and/or 400. It also will be appreciated that the system memory 1204 can be implemented in combination with and/or alternatively to memories 104, 204, 304 and/or 404. Likewise, it also will be appreciated that the processing unit 1206 can be implemented in combination with and/or alternatively to processors 106, 206, 306 and/or 406.

Memory 1204 can store one or more computer and/or machine readable, writable and/or executable components and/or instructions that, when executed by processing unit 1206 (e.g., a classical processor, a quantum processor and/or like processor), can facilitate performance of operations defined by the executable component(s) and/or instruction(s). For example, memory 1204 can store computer and/or machine readable, writable and/or executable components and/or instructions that, when executed by processing unit 1206, can facilitate execution of the one or more functions described herein relating to non-limiting systems 100, 200, 300 and/or 400 and/or error mitigation systems 102, 202, 302 and/or 402, as described herein with or without reference to the one or more figures of the one or more embodiments.

Memory 1204 can comprise volatile memory (e.g., random access memory (RAM), static RAM (SRAM), dynamic RAM (DRAM) and/or the like) and/or non-volatile memory (e.g., read only memory (ROM), programmable ROM (PROM), electrically programmable ROM (EPROM), electrically erasable programmable ROM (EEPROM) and/or the like) that can employ one or more memory architectures.

Processing unit 1206 can comprise one or more types of processors and/or electronic circuitry (e.g., a classical processor, a quantum processor and/or like processor) that can implement one or more computer and/or machine readable, writable and/or executable components and/or instructions that can be stored at memory 1204. For example, processing unit 1206 can perform one or more operations that can be specified by computer and/or machine readable, writable and/or executable components and/or instructions including, but not limited to, logic, control, input/output (I/O), arithmetic and/or the like. In one or more embodiments, processing unit 1206 can be any of one or more commercially available processors. In one or more embodiments, processing unit 1206 can comprise one or more central processing unit, multi-core processor, microprocessor, dual microprocessors, microcontroller, System on a Chip (SOC), array processor, vector processor, quantum processor and/or another type of processor. The examples of processing unit 1206 can be employed to implement any one or more embodiments described herein.

The system bus 1208 can couple system components including, but not limited to, the system memory 1204 to the processing unit 1206. The system bus 1208 can comprise any of one or more types of bus structure that can further interconnect to a memory bus (with or without a memory controller), a peripheral bus and/or a local bus using any of a variety of commercially available bus architectures. The system memory 1204 can include ROM 1210 and/or RAM 1212. A basic input/output system (BIOS) can be stored in a non-volatile memory such as ROM, erasable programmable read only memory (EPROM) and/or EEPROM, which BIOS contains the basic routines that help to transfer information among elements within the computer 1202, such as during startup. The RAM 1212 can include a high-speed RAM, such as static RAM for caching data.

The computer 1202 can include an internal hard disk drive (HDD) 1214 (e.g., EIDE, SATA), one or more external storage devices 1216 (e.g., a magnetic floppy disk drive (FDD), a memory stick or flash drive reader, a memory card reader and/or the like) and/or a drive 1220, e.g., such as a solid state drive or an optical disk drive, which can read or write from a disk 1222, such as a CD-ROM disc, a DVD, a BD and/or the like. Additionally and/or alternatively, where a solid state drive is involved, disk 1222 could not be included, unless separate. While the internal HDD 1214 is illustrated as located within the computer 1202, the internal HDD 1214 can also be configured for external use in a suitable chassis (not shown). Additionally, while not shown in operating environment 1200, a solid state drive (SSD) can be used in addition to, or in place of, an HDD 1214. The HDD 1214, external storage device(s) 1216 and drive 1220 can be connected to the system bus 1208 by an HDD interface 1224, an external storage interface 1226 and a drive interface 1228, respectively. The HDD interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, can also be used in the example operating environment, and/or that any such storage media can contain computer-executable instructions for performing the methods described herein.

A number of program modules can be stored in the drives and RAM 1212, including an operating system 1230, one or more applications 1232, other program modules 1234 and/or program data 1236. All or portions of the operating system, applications, modules and/or data can also be cached in the RAM 1212. The systems and/or methods described herein can be implemented utilizing one or more commercially available operating systems and/or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In a related embodiment, operating system 1230 can comprise one virtual machine (VM) of multiple VMs hosted at computer 1202. Furthermore, operating system 1230 can provide runtime environments, such as the JAVA runtime environment or the .NET framework, for applications 1232. Runtime environments are consistent execution environments that can allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and/or settings for an application.

Further, computer 1202 can be enabled with a security module, such as a trusted processing module (TPM). For instance, with a TPM, boot components hash next in time boot components and wait for a match of results to secured values before loading a next boot component. This process can take place at any layer in the code execution stack of computer 1202, e.g., applied at application execution level and/or at operating system (OS) kernel level, thereby enabling security at any level of code execution.

An entity can enter and/or transmit commands and/or information into the computer 1202 through one or more wired/wireless input devices, e.g., a keyboard 1238, a touch screen 1240 and/or a pointing device, such as a mouse 1242. Other input devices (not shown) can include a microphone, an infrared (IR) remote control, a radio frequency (RF) remote control and/or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint and/or iris scanner, and/or the like. These and other input devices can be connected to the processing unit 1206 through an input device interface 1244 that can be coupled to the system bus 1208, but can be connected by other interfaces, such as a parallel port, an IEEE 1394 serial port, a game port, a USB port, an IR interface, a BLUETOOTH® interface and/or the like.

A monitor 1246 or other type of display device can be alternatively and/or additionally connected to the system bus 1208 via an interface, such as a video adapter 1248. In addition to the monitor 1246, a computer typically includes other peripheral output devices (not shown), such as speakers, printers and/or the like.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device and/or other common network node, and typically includes many or all of the elements described relative to the computer 1202, although, for purposes of brevity, only a memory/storage device 1252 is illustrated. Additionally and/or alternatively, the computer 1202 can be coupled (e.g., communicatively, electrically, operatively, optically and/or the like) to one or more external systems, sources and/or devices (e.g., classical and/or quantum computing devices, communication devices and/or like device) via a data cable (e.g., High-Definition Multimedia Interface (HDMI), recommended standard (RS) 232, Ethernet cable and/or the like).

In one or more embodiments, a network can comprise one or more wired and/or wireless networks, including, but not limited to, a cellular network, a wide area network (WAN) (e.g., the Internet), or a local area network (LAN). For example, one or more embodiments described herein can communicate with one or more external systems, sources and/or devices, for instance, computing devices (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol and/or other proprietary and/or non-proprietary communication protocols. In a related example, one or more embodiments described herein can include hardware (e.g., a central processing unit (CPU), a transceiver, a decoder, quantum hardware, a quantum processor and/or the like), software (e.g., a set of threads, a set of processes, software in execution, quantum pulse schedule, quantum circuit, quantum gates and/or the like) and/or a combination of hardware and/or software that facilitates communicating information among one or more embodiments described herein and external systems, sources and/or devices (e.g., computing devices, communication devices and/or the like).

The logical connections depicted include wired/wireless connectivity to a local area network (LAN) 1254 and/or larger networks, e.g., a wide area network (WAN) 1256. LAN and WAN networking environments can be commonplace in offices and companies and can facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired and/or wireless communication to the LAN 1254, which can also include a wireless access point (AP) disposed thereon for communicating with the adapter 1258 in a wireless mode.

When used in a WAN networking environment, the computer 1202 can include a modem 1260 and/or can be connected to a communications server on the WAN 1256 via other means for establishing communications over the WAN 1256, such as by way of the Internet. The modem 1260, which can be internal and/or external and a wired and/or wireless device, can be connected to the system bus 1208 via the input device interface 1244. In a networked environment, program modules depicted relative to the computer 1202 or portions thereof can be stored in the remote memory/storage device 1252. It will be appreciated that the network connections shown are merely exemplary and one or more other means of establishing a communications link among the computers can be used.

When used in either a LAN or WAN networking environment, the computer 1202 can access cloud storage systems or other network-based storage systems in addition to, and/or in place of, external storage devices 1216 as described above, such as but not limited to, a network virtual machine providing one or more aspects of storage and/or processing of information. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, such as with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices and/or entities operatively disposed in wireless communication, e.g., a printer, scanner, desktop and/or portable computer, portable data assistant, communications satellite, telephone and/or any piece of equipment or location associated with a wirelessly detectable tag (e.g., a kiosk, news stand, store shelf and/or the like). This can include Wireless Fidelity (Wi-Fi) and BLUETOOTH® wireless technologies. Thus, the communication can be a predefined structure as with a conventional network or simply an ad hoc communication between at least two devices.

The illustrated embodiments described herein can be practiced in distributed computing environments (e.g., cloud computing environments), such as described below with respect to FIG. 13, where certain tasks are performed by remote processing devices that are linked through a communications network. In a distributed computing environment, program modules can be located both in local and/or remote memory storage devices.

For example, one or more embodiments described herein and/or one or more components thereof can employ one or more computing resources of the cloud computing environment 1350 described below with reference to FIG. 13, and/or with reference to the one or more functional abstraction layers (e.g., quantum software and/or the like) described below with reference to FIG. 14, to execute one or more operations in accordance with one or more embodiments described herein. For example, cloud computing environment 1350 and/or one or more of the functional abstraction layers 1460, 1470, 1480 and/or 1490 can comprise one or more classical computing devices (e.g., classical computer, classical processor, virtual machine, server and/or the like), quantum hardware and/or quantum software (e.g., quantum computing device, quantum computer, quantum processor, quantum circuit simulation software, superconducting circuit and/or the like) that can be employed by one or more embodiments described herein and/or components thereof to execute one or more operations in accordance with one or more embodiments described herein. For instance, one or more embodiments described herein and/or components thereof can employ such one or more classical and/or quantum computing resources to execute one or more classical and/or quantum: mathematical function, calculation and/or equation; computing and/or processing script; algorithm; model (e.g., artificial intelligence (AI) model, machine learning (ML) model and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but can specify location at a higher level of abstraction (e.g., country, state and/or datacenter).

Rapid elasticity: capabilities can be rapidly and elastically provisioned, in one or more cases automatically, to quickly scale out and rapidly released to quickly scale in. To the consumer, the capabilities available for provisioning can appear to be unlimited and can be purchased in any quantity at any time.

Measured service: cloud systems automatically control and optimize resource use by leveraging a metering capability at one or more levels of abstraction appropriate to the type of service (e.g., storage, processing, bandwidth and/or active user accounts). Resource usage can be monitored, controlled and/or reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage and/or individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems and/or storage, but has control over the deployed applications and possibly application hosting environment configurations.

Infrastructure as a Service (IaaS): the capability provided to the consumer is to provision processing, storage, networks and/or other fundamental computing resources where the consumer can deploy and run arbitrary software, which can include operating systems and applications. The consumer does not manage or control the underlying cloud infrastructure but has control over operating systems, storage, deployed applications and/or possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy and/or compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community or public) that remain unique entities but are bound together by standardized or proprietary technology that enables data and application portability (e.g., cloud bursting for load-balancing among clouds).

A cloud computing environment is service oriented with a focus on statelessness, low coupling, modularity and/or semantic interoperability. At the heart of cloud computing is an infrastructure that includes a network of interconnected nodes.

Moreover, the non-limiting systems 100, 200, 300 and/or 400 and/or the example operating environment 1200 can be associated with and/or be included in a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system, a communication system, a router system, a server system, a high availability server system (e.g., a Telecom server system), a Web server system, a file server system, a data server system, a disk array system, a powered insertion board system, a cloud-based system and/or the like. In accordance therewith, non-limiting systems 100, 200, 300 and/or 400 and/or example operating environment 1200 can be employed to use hardware and/or software to solve problems that are highly technical in nature, that are not abstract and/or that cannot be performed as a set of mental acts by a human.

Referring now to details of one or more aspects illustrated at FIG. 13, the illustrative cloud computing environment 1350 is depicted. As shown, cloud computing environment 1350 includes one or more cloud computing nodes 1310 with which local computing devices used by cloud consumers, such as, for example, personal digital assistant (PDA) or cellular telephone 1354A, desktop computer 1354B, laptop computer 1354C and/or automobile computer system 1354N can communicate. Although not illustrated in FIG. 13, cloud computing nodes 1310 can further comprise a quantum platform (e.g., quantum computer, quantum hardware, quantum software and/or the like) with which local computing devices used by cloud consumers can communicate. Cloud computing nodes 1310 can communicate with one another. They can be grouped (not shown) physically or virtually, in one or more networks, such as Private, Community, Public, or Hybrid clouds as described hereinabove, or a combination thereof. This allows cloud computing environment 1350 to offer infrastructure, platforms and/or software as services for which a cloud consumer does not need to maintain resources on a local computing device. It is understood that the types of computing devices 1354A-N shown in FIG. 13 are intended to be illustrative only and that cloud computing nodes 1310 and cloud computing environment 1350 can communicate with any type of computerized device over any type of network and/or network addressable connection (e.g., using a web browser).

Referring now to details of one or more aspects illustrated at FIG. 14, a set of functional abstraction layers is shown, such as provided by cloud computing environment 1350 (FIG. 13). One or more embodiments described herein can be associated with one or more functional abstraction layers described below with reference to FIG. 14 (e.g., hardware and software layer 1460, virtualization layer 1470, management layer 1480 and/or workloads layer 1490). It should be understood in advance that the components, layers and/or functions shown in FIG. 14 are intended to be illustrative only and embodiments described herein are not limited thereto. As depicted, the following layers and/or corresponding functions are provided:

Hardware and software layer 1460 can include hardware and software components. Examples of hardware components include: mainframes 1461; RISC (Reduced Instruction Set Computer) architecture-based servers 1462; servers 1463; blade servers 1464; storage devices 1465; and/or networks and/or networking components 1466. In one or more embodiments, software components can include network application server software 1467, quantum platform routing software 1468; and/or quantum software (not illustrated in FIG. 14).

Virtualization layer 1470 can provide an abstraction layer from which the following examples of virtual entities can be provided: virtual servers 1471; virtual storage 1472; virtual networks 1473, including virtual private networks; virtual applications and/or operating systems 1474; and/or virtual clients 1475.

In one example, management layer 1480 can provide the functions described below. Resource provisioning 1481 can provide dynamic procurement of computing resources and other resources that can be utilized to perform tasks within the cloud computing environment. Metering and Pricing 1482 can provide cost tracking as resources are utilized within the cloud computing environment, and/or billing and/or invoicing for consumption of these resources. In one example, these resources can include one or more application software licenses. Security can provide identity verification for cloud consumers and/or tasks, as well as protection for data and/or other resources. User (or entity) portal 1483 can provide access to the cloud computing environment for consumers and system administrators. Service level management 1484 can provide cloud computing resource allocation and/or management such that required service levels are met. Service Level Agreement (SLA) planning and fulfillment 1485 can provide pre-arrangement for, and procurement of, cloud computing resources for which a future requirement is anticipated in accordance with an SLA.

Workloads layer 1490 can provide examples of functionality for which the cloud computing environment can be utilized. Non-limiting examples of workloads and functions which can be provided from this layer include: mapping and navigation 1491; software development and lifecycle management 1492; virtual classroom education delivery 1493; data analytics processing 1494; transaction processing 1495; and/or application transformation software 1496.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, those skilled in the art will appreciate that the inventive computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a computation component that performs error mitigation employing less than a full set of assignment matrix (A-matrix) elements.

2. The system of claim 1, wherein
wherein the computation component computes the less than a full set of A-matrix elements employing data from observed bitstrings.

3. The system of claim 1,
wherein the computation component performs the error mitigation without constructing an A-matrix.

4. The system of claim 2,
wherein the computation component employs a renormalization factor relative to one or more of the observed bitstrings.

5. The system of claim 1,
wherein the computation component employs a function evaluator using noisy bitstring data and one or more calibration factors to compute the less than a full set of A-matrix elements.

6. The system of claim 1,
wherein the computation component employs an iterative solver using the less than a full set of A-matrix elements as an initial input set.

7. The system of claim 6,
wherein the computation component employs a preconditioner relative to the initial input set prior to employing the iterative solver.

8. A computer-implemented method, comprising:
performing, by a system operatively coupled to a processor, error mitigation employing less than a full set of assignment matrix (A-matrix) elements.

9. The computer-implemented method of claim 8, further comprising:
computing, by the system, the less than a full set of A-matrix elements employing data from observed bitstrings.

10. The computer-implemented method of claim 8,
performing, by the system, the error mitigation without constructing an A-matrix.

11. The computer-implemented method of claim 9,
employing, by the system, a renormalization factor relative to one or more of the observed bitstrings.

12. The computer-implemented method of claim 8,
employing, by the system, a function evaluator using noisy bitstring data and one or more calibration factors to compute the less than a full set of A-matrix elements.

13. The computer-implemented method of claim 8,
employing, by the system, an iterative solver using the less than a full set of A-matrix elements as an initial input set.

14. The computer-implemented method of claim 13,
employing, by the system, a preconditioner relative to the initial input set prior to employing the iterative solver.

15. A computer program product facilitating error mitigation, the computer program product comprising a computer readable storage medium having program instructions embodied therewith, the program instructions executable by a processor of the system to cause the processor to:
perform, by the processor, error mitigation employing less than a full set of assignment matrix (A-matrix) elements.

16. The computer program product of claim 15, wherein the program instructions are further executable to cause the processor to:
compute, by the processor, the less than a full set of A-matrix elements employing data from observed bitstrings.

17. The computer program product of claim 15, wherein the program instructions are further executable to cause the processor to:
perform, by the processor, the error mitigation without constructing an A-matrix.

18. The computer program product of claim 16, wherein the program instructions are further executable to cause the processor to:
employ, by the processor, a renormalization factor relative to one or more of the observed bitstrings.

19. The computer program product of claim 15, wherein the program instructions are further executable to cause the processor to:
employ, by the processor, a function evaluator using noisy bitstring data and one or more calibration factors to compute the less than a full set of A-matrix elements.

20. The computer program product of claim 15, wherein the program instructions are further executable to cause the processor to:
employ, by the processor, an iterative solver using the less than a full set of A-matrix elements as an initial input set.

21. The computer program product of claim 20, wherein the program instructions are further executable to cause the processor to:
employ, by the processor, a preconditioner relative to the initial input set prior to employing the iterative solver.

22. A system, comprising:
a memory that stores computer executable components; and
a processor that executes the computer executable components stored in the memory, wherein the computer executable components comprise:
a computation component that performs error mitigation employing less than a full set of assignment matrix (A-matrix) elements that are computed employing only data from observed bitstrings from one or more qubits.

23. The system of claim 22, wherein the computer executable component further comprise:
a determination component that obtains, from a quantum system, noisy measurement data comprising the observed bitstring data.

24. A system, comprising:
a memory that stores computer executable components; and
a processor that executes the computer executable components stored in the memory, wherein the computer executable components comprise:
a computation component that performs error mitigation employing an iterative solver using a truncated set of assignment matrix (A-matrix) elements as the initial input set for the iterative solver.

25. The system of claim 24,
wherein the truncated set of A-matrix elements are computed employing only data from observed bitstrings from one or more qubits and without constructing an A-matrix.
